(19) United States
(12) Patent Application Publication
(10) Pub. No.: US 2008/0101363 A1
(43) Pub. Date: May 1, 2008

(54) METHOD, SYSTEM AND APPARATUS FOR SUPPORTING SSM FORWARDING IN ETHERNET

(75) Inventor: Qiao Li, Guangdong (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Guangdong (CN)

(21) Appl. No.: 11/966,573

(22) Filed: Dec. 28, 2007

Related U.S. Application Data
(63) Continuation of application No. PCT/CN2007/070399, filed on Aug. 1, 2007.

(30) Foreign Application Priority Data
Aug. 1, 2006 (CN) 200610103987.5

(51) Int. Cl. H04L 12/56

(52) U.S. Cl. 370/390

(57) ABSTRACT

A method for supporting Source-Specific Multicast (SSM) forwarding in Ethernet includes: taking, by the router, a Source-Specific Destination Media Access Control address containing a Multicast Source-Group address pair as a DMAC address when encapsulating an SSM multicast IP packet into an multicast Ethernet packet; and encapsulating the SS-DMAC address into the multicast Ethernet packet; forwarding, by the Ethernet switch, the encapsulated multicast Ethernet packet according to the SS-DMAC address. Through encapsulating the SS-DMAC address into the multicast Ethernet packet, the Ethernet switch may support the SSM when forwarding the multicast Ethernet packet based on VLAN+DMAC. Embodiments of the present invention also provide system and apparatus for supporting the SSM forwarding. The solution provided by embodiments of the present invention lowers device cost and upgrade cost of a whole network lowers, provides compatibility with existed devices and reduces investment of operators.

### FIELD OF THE INVENTION

The present invention relates to network communication technologies, and more particularly, to Source-Specific Multicast (SSM) forwarding technologies in Ethernet.

### BACKGROUND OF THE INVENTION

In SSM, a host may join to a multicast group by Internet Group Management Protocol version 3 (IGMP v3). In an IGMP v3 packet, besides specifying an interested multicast group, the host also requires to report interests in receiving packets from which Source, i.e., specify a Source IP address (SIP). Thus, multicast packets from other Sources which the host is not interested in will not be received by the host. After applying the SSM, a router needs to forward the multicast packets based on a Multicast Source-Group address pair (S,G) to only forward the multicast packets from a specific (S, G) to the host, wherein G, denotes GIP, i.e., a multicast Group IP address, identified by a group IP address of a multicast IP packet.

For an Ethernet switch, its traditional layer 2 multicast forwarding is performed based on a Virtual Local Area Network (VLAN) and a Destination Media Access Control (DMAC) address in an Ethernet packet. The DMAC address is obtained through mapping of the multicast IP address G into the DMAC address. The mapping of the multicast IP address G into the DMAC address includes: obtain a VLAN value of an Ethernet packet from an outgoing interface of the multicast IP packet, each outgoing interface corresponds to one VLAN; and map the multicast IP address G into the multicast DMAC address. The DMAC address only relates to a destination multicast IP address and is referred to as an Any Source DMAC (AS-DMAC) address. As shown in FIG. 1, the multicast IP address has 32 bits. The high-order 4 bits of the multicast IP address are “1110”, indicating that this address is a multicast IP address. The multicast MAC address has 48 bits. The high-order 24 bits are “0x01005e”, bit 25 is “0” and the low-order 23 bits are the low-order 23 bits of the multicast IP address.

In a traditional mapping mechanism, the IP packets of the same multicast group G sent by different Sources S are mapped with the same VLAN+DMAC. Thus during the multicast forwarding based on the VLAN+DMAC, the Ethernet switch sends the IP packets to all the hosts subscribing to the multicast group G. Thus a host only subscribing to Source A without subscribing to Source B will also receive multicast packets from Source B. Therefore the hosts who have subscribed to different Sources in the same Group cannot be distinguished, i.e. the SSM forwarding by the Ethernet switch cannot be implemented.

A solution in the prior art for the Ethernet switch to support the SSM includes: enable the Ethernet switch to support the forwarding based on the (S, G). Specifically, add an (S, G) forwarding entry in the Ethernet switch, configure an (S, G)-based port list in the (S, G) forwarding entry through IGMP Snooping/Proxy, and forward IP packets based on the (S, G)-based port list. Since the Ethernet is capable of generating a logical topology tree through running a spanning tree protocol, the Ethernet switch need not perform Reverse Path Forwarding (RPF) check like the router during the forwarding based on the (S, G).

However, the above solution greatly increases hardware cost and software upgrade cost of a whole network and is not compatible with existing devices, which dramatically increases investments of operators. Therefore, the above solution is hard to implement.

Specifically, since the Ethernet switch is a link layer device, the forwarding only processes an Ethernet encapsulation. If the Ethernet switch adopts the forwarding based on the (S, G), the forwarding mechanism and protocol stack of the Ethernet switch are greatly changed. Thus, the Ethernet switch needs to be changed greatly and will be highly complicated. The existing Ethernet switch can hardly satisfy technology requirements of the solution and it is impossible to implement the solution only by software upgrade.

### SUMMARY OF THE INVENTION

Embodiments of the present invention provide method, system and apparatus for supporting Source-Specific Multicast (SSM) forwarding in Ethernet, so as to lower device cost and upgrade cost of a whole network, provide compatibility with existing devices and reduce investment of operators.

According to one embodiment of the present invention, a method for supporting SSM forwarding in Ethernet, applicable to a multicast network including a router and an Ethernet switch, includes:

taking, by the router, a Source-Specific Destination Media Access Control address containing a Multicast Source-Group address pair as a Destination Media Access Control address when encapsulating a Source-Specific Multicast IP packet into a multicast Ethernet packet; and encapsulating the Source-Specific Destination Media Access Control address into the multicast Ethernet packet; forwarding, by the Ethernet switch, the encapsulated multicast Ethernet packet according to the Source-Specific Destination Media Access Control address.

According to another embodiment of the present invention, a system for supporting SSM forwarding in Ethernet includes: a router, configured to take a Source-Specific Destination Media Access Control address containing information of a Multicast Source-Group address pair as a Destination Media Access Control address when encapsulating an Source-Specific Multicast IP packet into a multicast Ethernet packet, and encapsulate the Source-Specific Destination Media Access Control address into the multicast Ethernet packet; and an Ethernet switch, configured to forward the encapsulated multicast Ethernet packet according to the Source-Specific Destination Media Access Control address.

According to another embodiment of the present invention, a router includes:

a Source-Specific Destination Media Access Control address encapsulation unit, configured to take a Source-Specific Destination Media Access Control address containing information of an Multicast Source-Group address pair as a Destination Media Access Control address when encapsulating an Source-Specific Multicast IP packet into a multicast Ethernet packet, and encapsulate the Source-Specific Destination Media Access Control address into the multicast Ethernet packet.

According to another embodiment of the present invention, an Ethernet switch includes:

a storage unit, configured to store a corresponding relationship between a Multicast Source-Group address pair and a Source-Specific Destination Media Access Control address; a forwarding port list configuration unit, configured to determine a Source-Specific Destination Media Access Control address corresponding to a Multicast Source-Group address pair contained in an intercepted Internet Group Management Protocol uplink packet based on an Internet Group Management Protocol uplink packet and the corresponding relationship between the Multicast Source-Group address pair and the Source-Specific Destination Media Access Control address, and configure a forwarding port list based on a Virtual Local Area Network identifier and the Source-Specific Destination Media Access Control address.

By applying the solution provided by embodiments of the present invention, it is easy to enable the Ethernet switch to support the SSM forwarding and only forwarding components of an edge router need to be modified to support the SSM forwarding. The solution provided by embodiments of the present invention lowers device cost and upgrade cost of the whole network, provides compatibility with existing devices and reduces investment of operators.

### BRIEF DESCRIPTION OF THE DRAWINGS

FIG. 1 illustrates a mapping from a multicast IP address to a multicast AS-DMAC address according to the related art.

FIG. 2 is a flowchart illustrating a method for supporting the SSM forwarding in Ethernet according to an embodiment of the present invention.

FIG. 3 is a flowchart illustrating a mapping from an (S, G) to an SS-DMAC address in an Ethernet switch according to an embodiment of the present invention.

FIG. 4 is a flowchart illustrating a mapping from an (S, G) to an SS-DMAC address in a router according to an embodiment of the present invention.

FIG. 5 illustrates a network structure according to an embodiment of the present invention.

FIG. 6 illustrates a system structure according to an embodiment of the present invention.

### DETAILED DESCRIPTION OF THE INVENTION

In embodiments of the present invention, a Source-Specific DMAC (SS-DMAC) is derived from mapping a Multicast Source-Group address pair (S, G) to a DMAC. The Ethernet switch configures a forwarding port list based on the SS-DMAC address. A router takes the SS-DMAC address as a DMAC address and encapsulates the SS-DMAC address into a multicast Ethernet packet during Ethernet encapsulation. Thus, the SS-DMAC includes information of a Source IP (SIP), and the Ethernet switch may support the SSM during multicast forwarding based on VLAN+DMAC.

The method provided by embodiments of the present invention is applicable for a multicast network including a router and an Ethernet switch. The method includes: the router takes an SS-DMAC address containing information of an (S, G) as a DMAC address when encapsulating an SSM multicast IP packet into an multicast Ethernet packet; and encapsulates the SS-DMAC address into the multicast Ethernet packet. The Ethernet switch forwards the encapsulated multicast Ethernet packet according to the SS-DMAC address.

Preferably, the method in an embodiment of the present invention may also include: configure a consistent corresponding relationship between the (S, G) and the SS-DMAC address respectively in the Ethernet switch and the router; after intercepting an IGMP uplink packet through IGMP Snooping/Proxy, the Ethernet switch determines the SS-DMAC address corresponding to the (S, G) contained in the IGMP uplink packet based on the corresponding relationship configured in the Ethernet switch; configures a forwarding port list based on a VLAN identifier and the SS-DMAC address, and forwards the IGMP uplink packet to the router.

Specifically, the encapsulation of the SSM multicast IP packet into the multicast Ethernet packet by the router and the forwarding of the encapsulated multicast Ethernet packet by the Ethernet switch include the following.

(1) The router determines an SS-DMAC address corresponding to the (S, G) of the SSM multicast IP packet according to the corresponding relationship between the (S, G) and the SS-DMAC address, and takes the SS-DMAC address containing information of an (S, G) as a DMAC address when encapsulating the SSM multicast IP packet into the multicast Ethernet packet; encapsulates the SS-DMAC address into the multicast Ethernet packet; and forwards the encapsulated multicast Ethernet packet to the Ethernet switch.

Specifically, when encapsulating the SSM multicast IP packet, the router determines whether to adopt the SS-DMAC address to encapsulate the SSM multicast IP packet based on a configuration of a routing interface of the router; and encapsulates the SSM multicast IP packet based on the determined result.

(1.1) If determining to adopt the SS-DMAC address to encapsulate the SSM multicast IP packet, the router further determines whether there is an SS-DMAC corresponding to the (S, G) of the SSM multicast IP packet.

If there is an SS-DMAC address corresponding to the (S, G) of the SSM multicast IP packet, the SS-DMAC address is adopted to encapsulate the SSM multicast IP packet.

If there is no SS-DMAC address corresponding to the (S, G) of the SSM multicast IP packet, the router further determines whether it is allowed to adopt the AS-DMAC address to encapsulate the SSM multicast IP packet based on the configuration of the routing interface.

(1.2) If determining not to adopt the SS-DMAC address to encapsulate the SSM multicast IP packet, the router encapsulates the AS-DMAC address into the SSM multicast IP packet, and forwards the encapsulated multicast Ethernet packet to the Ethernet switch.

Specifically, if it is allowed to adopt the AS-DMAC to encapsulate the SSM multicast IP packet, the router encapsulates the AS-DMAC address into the SSM multicast IP packet, and forwards the encapsulated multicast Ethernet packet to the Ethernet switch; otherwise, discards the SSM multicast IP packet.

Step (1) may further include: the router changes or forbids a check of the corresponding relationship between the DMAC and a multicast GIP address at a routing interface receiving the multicast Ethernet packet carrying information of SS-DMAC address Thus, the router may receive the multicast Ethernet packet containing the DMAC address which is not the AS-DMAC address corresponding to the GIP.

(2) The Ethernet switch forwards the encapsulated multicast Ethernet packet to a corresponding port according to the forwarding port list configured based on the VLAN identifier and the SS-DMAC address.

When configuring the forwarding port list, the Ethernet switch determines whether to adopt the SS-DMAC address to configure the forwarding port list based on the VLAN configuration of the Ethernet switch.

(1) If determining to adopt the SS-DMAC address to configure the forwarding port list, the Ethernet switch further determines whether there is an SS-DMAC address corresponding to the (S, G) contained in the IGMP uplink packet, and configures the forwarding port list based on a determination result.

Specifically, if there is an SS-DMAC address corresponding to the (S, G) contained in the IGMP uplink packet, configure the forwarding port list based on the VLAN identifier and the SS-DMAC address.

If there is no SS-DMAC address corresponding to the (S, G) contained in the IGMP uplink packet, the Ethernet switch further determines whether it is allowed to adopt the AS-DMAC address to configure the forwarding port list according to the VLAN configuration of the Ethernet switch, and configures the forwarding port list based on a determination result.

(2) If determining not to adopt the SS-DMAC address to configure the forwarding port list, the Ethernet switch configures the forwarding port list based on the VLAN identifier and an AS-DMAC address.

Specifically, if it is allowed to adopt the AS-DMAC address to configure the forwarding port list, configure the forwarding port list based on the VLAN identifier and the AS-DMAC address; otherwise, discard the IGMP uplink packet.

The method in an embodiment of the present invention may include:

configure a corresponding relationship between the (S, G) of the SSM multicast IP packet and the SS-DMAC address in the router. When the router encapsulates the SSM multicast IP packet, instead of adopting the AS-DMAC address only based on the Group IP address, the router obtains the SS-DMAC address according to the corresponding relationship between the (S, G) and the SS-DMAC address, and takes the SS-DMAC address as the DMAC address for encapsulating the SSM multicast IP packet.

Thus, for the same multicast Group, a plurality of SS-DMAC addresses may be obtained for encapsulation based on different SIPs, wherein the SS-DMAC address includes information of the SIP and the destination multicast IP address.

Meanwhile, a corresponding relationship between the (S, G) and the SS-DMAC address consistent with that in the router is configured in the Ethernet switch.

During IGMP Snooping/Proxy, the Ethernet switch may obtain the SS-DMAC according to the (S, G) contained in the IGMP uplink packet. And during subsequently IGMP Snooping/Proxy, when it is needed to configure the forwarding port list based on the VLAN+DMAC, the Ethernet switch adopts the SS-DMAC to replace the AS-DMAC to configure the forwarding port list.

If the IGMP uplink packet includes a plurality of (S, G), respectively configure an item for each (S, G) according to the corresponding SS-DMAC address.

The corresponding relationship between the (S, G) and the SS-DMAC address may be configured by a mapping table between the (S, G) and the SS-DMAC address or by a HASH function between the (S, G) and the SS-DMAC address, or else.

The router may enable or disable the SS-DMAC function according to configuration of the routing interface. If a routing interface desires to receive multicast Ethernet packet containing the SS-DMAC address, a check of the corresponding relationship between the DMAC and the destination multicast Group IP address needs to be changed or forbidden. Thus, the router may receive the multicast Ethernet packet containing the DMAC address which is not the AS-DMAC address corresponding to the GIP.

When mapping the (S, G) to the SS-DMAC address, the packet without a corresponding SS-DMAC address may be discarded or be configured to adopt the AS-DMAC address. For the router, this option may be configured based on the routing interface. For the Ethernet switch, this option may be configured based on the VLAN of the Ethernet switch.

To make the technical solution of the present invention clearer, the embodiments are further described hereinafter with reference to accompanying drawings.

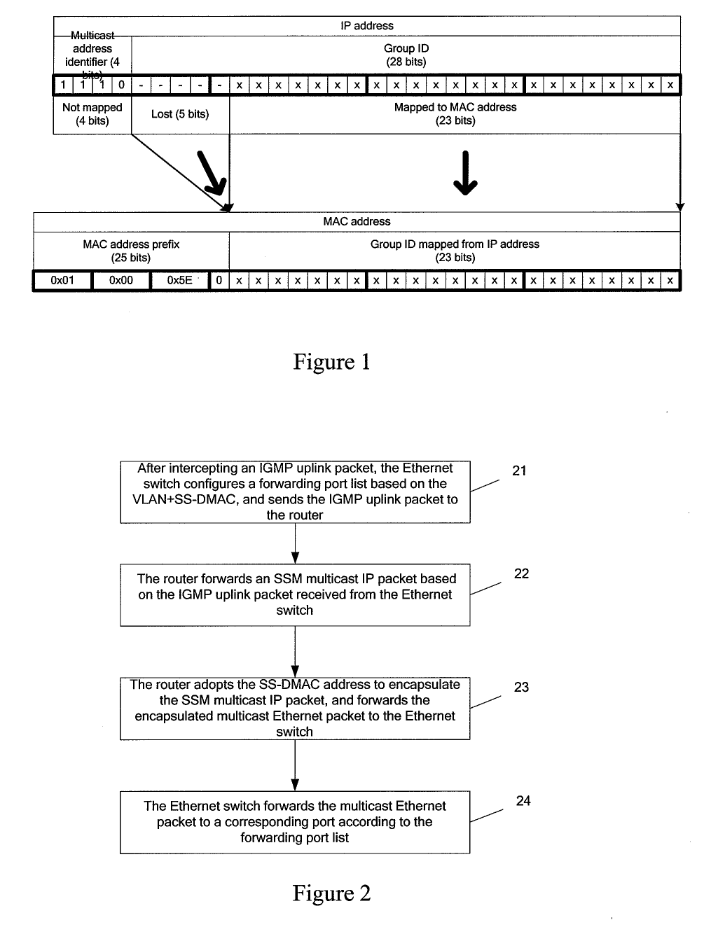

According to an embodiment of the present invention, the method for supporting SSM forwarding in Ethernet is shown as FIG. 2, includes the following blocks:

Block 21: After intercepting an IGMP uplink packet, the Ethernet switch configures a forwarding port list based on the VLAN+SS-DMAC, and sends the IGMP uplink packet to the router.

Specifically, when intercepting the IGMP uplink packet during IGMP Snooping/Proxy, the Ethernet switch obtains an SS-DMAC address corresponding to the (S, G) contained in the IGMP uplink packet based on a corresponding relationship between the (S, G) and the SS-DMAC address pre-configured in the Ethernet switch, e.g., through searching a mapping table between the (S, G) and the SS-DMAC address.

Then the Ethernet switch configures the forwarding port list based on the SS-DMAC address and the VLAN identifier, and forwards the IGMP uplink packet to the router.

In this way, the Ethernet switch may configure different forwarding port lists based on different SS-DMAC addresses.

Block 22: The router forwards an SSM multicast IP packet based on the IGMP uplink packet received from the Ethernet switch.

Block 23: When encapsulating the SSM multicast IP packet, the router obtains the SS-DMAC address corresponding to the (S, G) of the SSM multicast IP packet based on a corresponding relationship between the (S, G) and the SS-DMAC address pre-configured in the router, e.g., through searching a mapping table between the (S, G) and SS-DMAC address.

Then the router takes the SS-DMAC address as the DMAC address for an Ethernet multicast packet, encapsulates the SS-DMAC address into the Ethernet multicast packet, and forwards the encapsulated Ethernet multicast packet to the Ethernet switch.

The corresponding relationship between the (S, G) and the SS-DMAC address pre-configured in the router is consistent with that pre-configured in the Ethernet switch in block 21.

Block 24: After receiving the Ethernet multicast packet containing the SS-DMAC address, the Ethernet switch searches the forwarding port list according to a VLAN identifier and the SS-DMAC address in the Ethernet multicast packet, sends the Ethernet multicast packet to a corresponding port based on port information in the forwarding port list, and then forwards the Ethernet multicast packet to a corresponding user.

Thus, the host (user) connecting to this port may receive the multicast of a corresponding SIP, thereby the SSM forwarding may be implemented by the Ethernet switch.

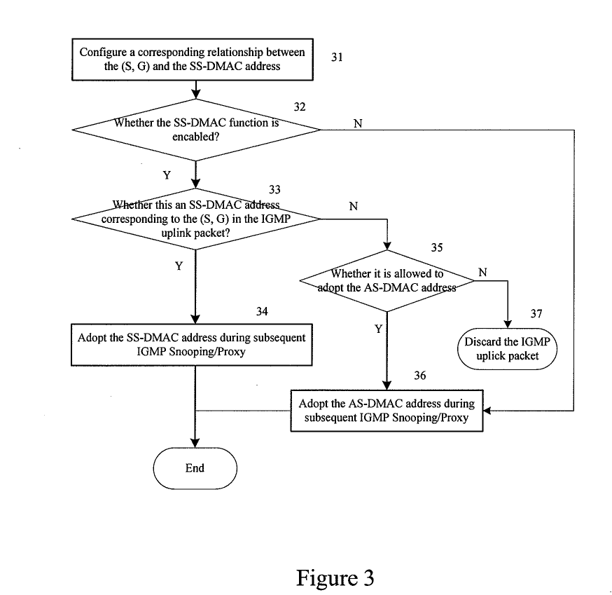

Based on the above method, another embodiment of the present invention provides an additional process for determining whether to activate the SS-DMAC function and for dealing with an unknown (S, G), as shown in FIG. 3. The process includes:

Block 31: Configure a corresponding relationship between the (S, G) and the SS-DMAC address in the Ethernet switch.

A mapping table between the (S, G) and the SS-DMAC address may be employed to configure the corresponding relationship between the (S, G) and the SS-DMAC in the Ethernet switch.

Block 32: After intercepting an IGMP uplink packet, the Ethernet switch determines whether to activate the SS-DMAC function according to a VLAN configuration of the Ethernet switch.

If the SS-DMAC function is activated, proceed to block 33; otherwise, proceed to block 36.

Block 33: Determine whether there is an SS-DMAC address corresponding to the (S, G) contained in the IGMP uplink packet.

If there is an SS-DMAC corresponding to the (S, G) contained in the IGMP uplink packet in the mapping table between the (S, G) and the SS-DMAC address, proceed to block 34; otherwise, proceed to block 35.

Block 34: The Ethernet switch configures the forwarding port list base on the VLAN identifier and the SS-DMAC address.

Block 35: If there is no SS-DMAC address corresponding to the (S, G) contained in the IGMP uplink packet in the mapping table between the (S, G) and the SS-DMAC address, determine whether it is allowed to adopt the AS-DMAC address to configure the forwarding port list according to the VLAN configuration of the Ethernet switch.

If it is allowed to adopt the AS-DMAC address to configure the forwarding port list, proceed to block 36; otherwise, proceed to block 37.

Block 36: The Ethernet switch configures the forwarding port list based on the VLAN identifier and the AS-DMAC address.

In this case, since the forwarding port list is configured based on the VLAN identifier and the AS-DMAC address, the Ethernet switch cannot implement the SSM forwarding.

Block 37: Discard the IGMP uplink packet.

If there is no SS-DMAC address corresponding to the (S, G) contained in the IGMP uplink packet in the mapping table between the (S, G) and the SS-DMAC address, and the forwarding port list cannot be configured adopting the AS-DMAC address in the Ethernet switch according to the VLAN configuration of the Ethernet switch, discard the IGMP uplink packet.

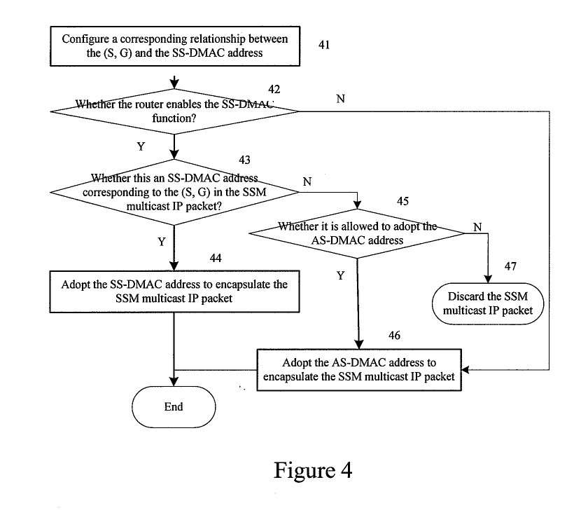

Based on above method, another embodiment of the present invention still provides an additional process for determining whether to activate the SS-DMAC function and for dealing with an unknown (S, G) in the router, as shown in FIG. 4. The process includes:

Block 41: Configure a corresponding relationship between the (S, G) and the SS-DMAC address in the router.

A mapping table between the (S, G) and the SS-DMAC may be employed to configure the corresponding relationship between the (S, G) and the SS-DMAC address.

Thus, at the same routing interface of the router, multiple SS-DMAC addresses may be encapsulated for the same destination multicast IP address based on different SIPs besides an AS-DMAC address.

Block 42: When forwarding an SSM multicast IP packet, the router determines whether to adopt the SS-DMAC address to encapsulate the SSM multicast IP packet into a multicast Ethernet packet based on a configuration of the routing interface.

If the SS-DMAC address is adopted to encapsulate the SSM multicast IP packet into the multicast Ethernet packet, proceed to block 43; otherwise, proceed to block 46.

Block 43: Determine whether there is an SS-DMAC address corresponding to the (S, G) of the SSM multicast IP packet.

If there is an SS-DMAC corresponding to the (S, G) of the SSM multicast IP packet in the mapping table between the (S, G) and SS-DMAC address, proceed to block 44; otherwise, proceed to block 45.

Block 44: When encapsulating the SSM multicast IP packet into the multicast Ethernet packet, the router takes the SS-DMAC address corresponding to the (S, G) of the SSM multicast IP packet as the DMAC address, encapsulates the SS-DMAC address into the multicast Ethernet packet, and forwards the encapsulated multicast Ethernet packet to the Ethernet switch.

Block 45: Determine whether it is allowed to adopt the AS-DMAC address to encapsulate the SSM multicast IP packet containing an unknown (S, G) into a multicast Ethernet packet.

In embodiments of the present invention, the (S, G) which has no corresponding SS-DMAC address is referred to as an unknown (S, G).

If there is no SS-DMAC address corresponding to the (S, G) of the SSM multicast IP packet in the mapping table between the (S, G) and the SS-DMAC address, determine whether it is allowed to adopt the AS-DMAC address to encapsulate the SSM multicast IP packet into the multicast Ethernet packet based on the configuration of the routing interface.

If it is allowed to adopt the AS-DMAC address to encapsulate the SSM multicast IP packet containing the unknown (S, G) into the multicast Ethernet packet, proceed to block 46; otherwise, proceed to 47.

Block 46: When encapsulating the SSM multicast IP packet into the multicast Ethernet packet, the router takes the AS-DMAC address as the DMAC address, encapsulates the AS-DMAC address into the multicast Ethernet packet, and forwards the encapsulated multicast Ethernet packet to the Ethernet switch.

In this case, since the AS-DMAC address is encapsulated in the multicast Ethernet packet, the SSM forwarding cannot be implemented.

Block 47: Discard the SSM multicast IP packet.

If there is no SS-DMAC address corresponding to the (S, G) of the SSM multicast IP packet in the mapping table between the (S, G) and the SS-DMAC address, and the routing interface does not allow to adopt the AS-DMAC address to encapsulate the SSM multicast IP packet into the multicast Ethernet packet, discard the SSM multicast IP packet.

The Ethernet switch in the embodiments of the present invention may be various forwarding devices adopting Ethernet technology, including an Ethernet switch, an IP Digital Subscriber Line Access Multiplexer (IP DSLAM) based on Ethernet forwarding, etc.

Preferably, the method provided by embodiments of the present invention may be implemented at an incoming interface of an edge router. The edge router refers to the router which has a routing interface directly connected with a host or connected with the host through an Ethernet bridge. And the incoming interface of the edge router refers to the interface only connected with the host (directly or via the Ethernet switch) but not connected with another router. The incoming interface of the edge router is usually connected with a relatively large layer 2 network (e.g., in the case of a telecommunication access network). Multicast packets are forwarded in the Ethernet through the layer 2 network, and forwarded to the host by an edge Ethernet switch. Through activating the SS-DMAC function at the incoming interface of the edge router, the layer 2 network may support the SSM. For a non-incoming interface of the edge router, since there is a router at a next hop, the multicast packet is forwarded by the router instead of the Ethernet switch. Therefore, the SS-DMAC function is not required and may be disabled at the non-incoming interface of the edge router.

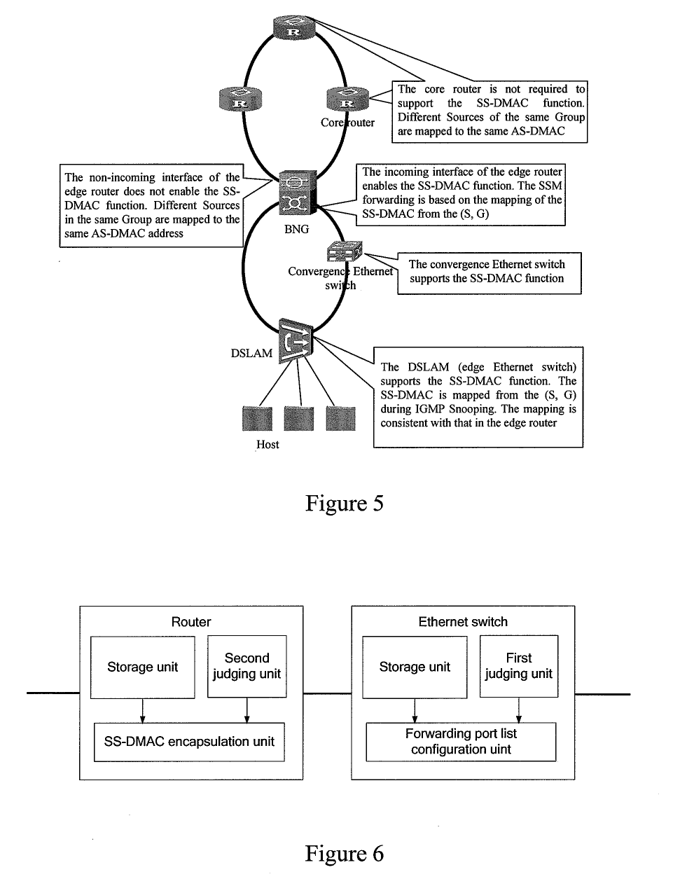

With a Digital Subscriber Line (DSL) access network as example, an IP DSLAM access network usually adopts Ethernet technology to implement multicast forwarding. To implement the SSM multicast forwarding, a Broadband Network Gateway (BNG) and the DSLAM are required to support the SS-DMAC function, as shown in FIG. 5. The BNG enables the SS-DMAC function at an incoming interface but disables the SS-DMAC function at a core network interface. The DSLAM and a convergence switch enable the SS-DMAC function. The router in a core network is not required to support the SS-DMAC function. When the SS-DMAC is adopted for the SSM forwarding, the edge router needs to change or forbid a corresponding relationship check between the multicast AS-DMAC address and a destination multicast IP address.

An embodiment of the present invention also provides a system for supporting the SSM forwarding in Ethernet, as shown in FIG. 6. The system includes a router, configured to take a Source-Specific Destination Media Access Control, SS-DMAC, address containing information of an (S, G) as a DMAC address when encapsulating an SSM multicast IP packet into a multicast Ethernet packet, and encapsulate the SS-DMAC address into the multicast Ethernet packet; and an Ethernet switch, configured to forward the encapsulated multicast Ethernet packet according to the SS-DMAC.

The router and the Ethernet switch respectively further include a storage unit, configured to store a consistent corresponding relationship between the (S, G) and the SS-DMAC address.

The router may further include an SS-DMAC encapsulating unit, configured to take the SS-DMAC address containing the information of the (S, G) as the DMAC address when encapsulating the SSM multicast IP packet into the multicast Ethernet packet, and encapsulate the SS-DMAC address into the multicast Ethernet packet.

The Ethernet switch may further include a forwarding port list configuration unit, configured to determine the SS-DMAC address corresponding to the (S, G) contained in an intercepted IGMP uplink packet based on the IGMP uplink packet and the corresponding relationship between the (S, G) and the SS-DMAC address, and configure a forwarding port list based on a Virtual Local Area Network, VLAN, identifier and the SS-DMAC address.

The Ethernet switch may further include a fist judging unit, configured to determine whether to adopt the SS-DMAC address to configure the forwarding port list according to a VLAN configuration of the Ethernet switch, and trigger the forwarding port list configuration unit if determining to adopt the SS-DMAC address to configure the forwarding port list.

The router may further include a second judging unit, configured to determine whether to adopt the SS-DMAC address to encapsulate the SSM multicast IP packet based on a configuration of a routing interface of the router, and trigger the SS-DMAC encapsulation unit if determining to adopt the SS-DMAC address to encapsulate the SSM multicast IP packet.

By applying the solution provided by the embodiments of the present invention, the Ethernet switch may easily support the SSM forwarding.

Specifically, the forwarding mechanism based on VLAN+DMAC and the protocol stack of the Ethernet switch need not be changed. And only the forwarding components of an edge router and the IGMP snooping component of the Ethernet switch need to be modified, i.e., the Ethernet switch may support SSM forwarding without much hardware modification. The Ethernet switch may implement the method of the embodiments of the present invention through software upgrade, i.e., support the SSM forwarding through software upgrade.

Therefore, the solution provided by embodiments of the present invention lowers device cost and upgrade cost of a whole network, provides compatibility with existed devices and reduces investment of operators.

The foregoing is only preferred embodiments of the present invention. The protection scope of the present invention is not limited to the above description. Any alteration or substitution that is within the technical scope disclosed by the present invention and can easily occur to those skilled in the art should be covered in the protection scope of the present invention. Hence the protection scope of the present invention should be determined by the statements in claims.

1. A method for supporting Source-Specific Multicast in Ethernet, applicable to a multicast network comprising a router and an Ethernet switch, comprising:
taking, by the router, a Source-Specific Destination Media Access Control address containing a Multicast Source-Group address pair as a Destination Media Access Control address when encapsulating a Source-Specific Multicast IP packet into a multicast Ethernet packet; and encapsulating the Source-Specific Destination Media Access Control address into the multicast Ethernet packet;
forwarding, by the Ethernet switch, the encapsulated multicast Ethernet packet according to the Source-Specific Destination Media Access Control address.

2. The method of claim 1, further comprising:
configuring a corresponding relationship between the Source-Specific Destination Media Access Control address and the Multicast Source-Group address pair respectively in the Ethernet switch and the router;
after intercepting an Internet Group Management Protocol uplink packet through Internet Group Management Protocol Snooping/Proxy, determining, by the Ethernet switch, the Source-Specific Destination Media Access Control address corresponding to the Multicast Source-Group address pair contained in the Internet Group Management Protocol uplink packet based on the corresponding relationship configured in the Ethernet switch; and
configuring a forwarding port list based on a Virtual Local Area Network identifier and the Source-Specific Destination Media Access Control address.

3. The method of claim 2, further comprising:
determining, by the Ethernet switch, whether to adopt the Source-Specific Destination Media Access Control address to configure the forwarding port list according to a Virtual Local Area Network configuration of the Ethernet switch before configuring the forwarding port list;
if determining to adopt the Source-Specific Destination Media Access Control address to configure the forwarding port list, determining, by the Ethernet switch, whether there is a Source-Specific Destination Media Access Control address corresponding to the Multicast Source-Group address pair contained in the Internet Group Management Protocol uplink packet, and configuring the forwarding port list based on a determination result;
if determining not to adopt the Source-Specific Destination Media Access Control address to configure the forwarding port list, configuring, by the Ethernet switch, the forwarding port list based on the Virtual Local Area Network identifier and an Any Source Destination Media Access Control address.

4. The method of claim 3, wherein the configuring the forwarding port list based on a determination result comprises:
if there is a Source-Specific Destination Media Access Control address corresponding to the Multicast Source-Group address pair contained in the Internet Group Management Protocol uplink packet, configuring, by the Ethernet switch, the forwarding port list based on the Virtual Local Area Network identifier and the Source-Specific Destination Media Access Control address;
if there is no Source-Specific Destination Media Access Control address corresponding to the Multicast Source-Group address pair contained in the Internet Group Management Protocol uplink packet, determining, by the Ethernet switch, whether it is allowed to adopt the Any Source Destination Media Access Control address to configure the forwarding port list according to the Virtual Local Area Network configuration of the Ethernet switch;
if it is allowed to adopt the Any Source Destination Media Access Control address to configure the forwarding port list, configuring the forwarding port list based on the Virtual Local Area Network identifier and the Any Source Destination Media Access Control address; otherwise, discarding the Internet Group Management Protocol uplink packet.

5. The method of claim 1, wherein the encapsulating a Source-Specific Multicast IP packet into a multicast Ethernet packet comprises:
determining, by the router, whether to adopt the Source-Specific Destination Media Access Control address to encapsulate the Source-Specific Multicast IP packet based on a configuration of a routing interface of the router;
if determining to adopt the Source-Specific Destination Media Access Control address to encapsulate the Source-Specific Multicast IP packet, adopting the Source-Specific Destination Media Access Control address to encapsulate the Source-Specific Multicast IP packet; otherwise, adopting an Any Source Destination Media Access Control address as the Destination Media Access Control address to encapsulate the Source-Specific Multicast IP packet.

6. The method of claim 5, wherein the adopting the Source-Specific Destination Media Access Control address to encapsulate the Source-Specific Multicast IP packet comprises:
determining whether there is an Source-Specific Destination Media Access Control corresponding to the Multicast Source-Group address pair of the Source-Specific Multicast IP packet;
if there is a Source-Specific Destination Media Access Control address corresponding to the Multicast Source-Group address pair of the Source-Specific Multicast IP packet, adopting the Source-Specific Destination Media Access Control address to encapsulate the Source-Specific Multicast IP packet;
if there is no Source-Specific Destination Media Access Control address corresponding to the Multicast Source-Group address pair of the Source-Specific Multicast IP packet, determining whether it is allowed to adopt the Any Source Destination Media Access Control address to encapsulate the Source-Specific Multicast IP packet based on the configuration of the routing interface;
if it is allowed to adopt the Any Source Destination Media Access Control address to encapsulate the Source-Specific Multicast IP packet, taking the Any Source Destination Media Access Control address as the Destination Media Access Control address, encapsulating the Any Source Destination Media Access Control address into the Source-Specific Multicast IP packet; otherwise, discarding the Source-Specific Multicast IP packet.

7. The method of claim 1, further comprising:
changing or forbidding, by the router, a corresponding relationship check between the Destination Media Access Control and a multicast Group IP address at a routing interface receiving the multicast Ethernet packet carrying information of Source-Specific Destination Media Access Control address.

8. A system for supporting Source-Specific Multicast forwarding in Ethernet, comprising:
a router, configured to take a Source-Specific Destination Media Access Control address containing information of a Multicast Source-Group address pair as a Destination Media Access Control address when encapsulating an Source-Specific Multicast IP packet into a multicast Ethernet packet, and encapsulate the Source-Specific Destination Media Access Control address into the multicast Ethernet packet; and
an Ethernet switch, configured to forward the encapsulated multicast Ethernet packet according to the Source-Specific Destination Media Access Control address.

9. The system of claim 8, wherein the router and the Ethernet switch respectively further comprises a storage unit, configured to store a consistent corresponding relationship between the Multicast Source-Group address pair and the Source-Specific Destination Media Access Control address; and
the router further comprises an Source-Specific Destination Media Access Control encapsulating unit, configured to take the Source-Specific Destination Media Access Control address containing the information of the Multicast Source-Group address pair as the Destination Media Access Control address when encapsulating the Source-Specific Multicast IP packet into the multicast Ethernet packet, and encapsulate the Source-Specific Destination Media Access Control address into the multicast Ethernet packet;
the Ethernet switch further comprises a forwarding port list configuration unit, configured to determine the Source-Specific Destination Media Access Control address corresponding to the Multicast Source-Group address pair contained in an intercepted Internet Group Management Protocol uplink packet based on the Internet Group Management Protocol uplink packet and the corresponding relationship between the Multicast Source-Group address pair and the Source-Specific Destination Media Access Control address, and configure a forwarding port list based on a Virtual Local Area Network identifier and the Source-Specific Destination Media Access Control address.

10. The system of claim 9, wherein the Ethernet switch further comprises a first judging unit, configured to determine whether to adopt the Source-Specific Destination Media Access Control address to configure the forwarding port list according to a Virtual Local Area Network configuration of the Ethernet switch, and trigger the forwarding port list configuration unit if determining to adopt the Source-Specific Destination Media Access Control address to configure the forwarding port list.

11. The system of claim 8, wherein the router further comprises a second judging unit, configured to determine whether to adopt the Source-Specific Destination Media Access Control address to encapsulate the Source-Specific Multicast IP packet based on a configuration of a routing interface of the router, and trigger the Source-Specific Destination Media Access Control encapsulation unit if determining to adopt the Source-Specific Destination Media Access Control address to encapsulate the Source-Specific Multicast IP packet.

12. A router for supporting Source-Specific Multicast forwarding, comprising:
a Source-Specific Destination Media Access Control address encapsulation unit, configured to take a Source-Specific Destination Media Access Control address containing information of an Multicast Source-Group address pair as a Destination Media Access Control address when encapsulating an Source-Specific Multicast IP packet into a multicast Ethernet packet, and encapsulate the Source-Specific Destination Media Access Control address into the multicast Ethernet packet.

13. The router of claim 12, further comprising:
a storage unit, configured to store a corresponding relationship between the Multicast Source-Group address pair and the Source-Specific Destination Media Access Control address.

14. The router of claim 12, further comprising:
a judging unit, configured to determine whether to adopt the Source-Specific Destination Media Access Control address to encapsulate the Source-Specific Multicast IP packet based on a configuration of a routing interface of the router, and trigger the Source-Specific Destination Media Access Control encapsulation unit if determining to adopt the Source-Specific Destination Media Access Control address to encapsulate the Source-Specific Multicast IP packet.

15. An Ethernet switch for supporting Source-Specific Multicast forwarding, comprising:
a storage unit, configured to store a corresponding relationship between a Multicast Source-Group address pair and a Source-Specific Destination Media Access Control address;
a forwarding port list configuration unit, configured to determine a Source-Specific Destination Media Access Control address corresponding to a Multicast Source-Group address pair contained in an intercepted Internet Group Management Protocol uplink packet based on an Internet Group Management Protocol uplink packet and the corresponding relationship between the Multicast Source-Group address pair and the Source-Specific Destination Media Access Control address, and configure a forwarding port list based on a Virtual Local Area Network identifier and the Source-Specific Destination Media Access Control address.

16. The Ethernet switch of claim 15, further comprising:
a judging unit, configured to determine whether to adopt the Source-Specific Destination Media Access Control address to configure the forwarding port list according to a Virtual Local Area Network configuration of the Ethernet switch, and trigger the forwarding port list configuration unit if determining to adopt the Source-Specific Destination Media Access Control address to configure the forwarding port list.
